(19) United States
(12) Patent Application Publication
(10) Pub. No.: US 2021/0027306 A1
(43) Pub. Date: Jan. 28, 2021

(54) SYSTEM TO AUTOMATICALLY FIND, CLASSIFY, AND TAKE ACTIONS AGAINST COUNTERFEIT PRODUCTS AND/OR FAKE ASSETS ONLINE

(71) Applicant: Cisco Technology, Inc., San Jose, CA (US)

(72) Inventors: Ram Abhinav Somaraju, Mont-Sur-Rolle (CH); Hervé Muyal, Gland (CH); Marcelo Yannuzzi Sánchez, Nuvilly (CH); Carlos M. Pignataro, Cary, NC (US)

(21) Appl. No.: 16/519,355

(22) Filed: Jul. 23, 2019

(51) Int. Cl. G06Q 30/00; H04L 29/06; G06K 9/62; G06N 20/00; G06Q 50/00

(52) U.S. Cl. CPC G06Q 30/0185; H04L 63/1483; G06Q 50/01; G06N 20/00; G06K 9/6267

(57) ABSTRACT

A management system performs a focused search to find uniform resource identifiers (URIs) of potentially counterfeit products and/or fake assets online, performs a search for adjacencies of blacklist URIs of counterfeit products and/or fake assets online to find additional URIs of potentially counterfeit products and/or fake assets online that are related to the blacklist URIs, and adds the URIs and the additional URIs to a URI list. The management system classifies, by a machine learning classifier, each URI on the URI list as one of a blacklist URI of counterfeit products and/or fake assets online, and a whitelist URI of authentic products and/or assets online, and repeats the performing the search for adjacencies using blacklist URIs resulting from the classifying, the adding, and the classifying operations, and removes access to counterfeit and/or fake assets online revealed by the focused search, the search for adjacencies, or the classifying.

### TECHNICAL FIELD

The present disclosure relates to techniques to detect and intervene against counterfeit products and/or fake assets online.

### BACKGROUND

The sale of counterfeit products online costs enterprises (including companies and individuals alike engaged in commerce) billions of dollars annually. Products such as medicines, luxury goods, and hardware are heavily counterfeited online, making this an urgent topic for several industries. This problem damages enterprises at multiple levels. It not only impacts their sales and revenues but also affects their brand and customer relationships. In segments such as pharma or hardware, counterfeit products sold online can cause health and safety issues, with negative connotations for the brands. Enterprises are forced to expend considerable effort, time, and money to take down websites impersonating authentic enterprises selling counterfeit products. Conventional techniques to combat counterfeit products online heavily depend on manual intervention, which is slow and costly. This is due to the absence of truly automated solutions capable of searching, classifying and taking actions against counterfeit products and/or fake assets online.

### BRIEF DESCRIPTION OF THE DRAWINGS

FIG. 1 is a block diagram of a network environment in which embodiments directed to automatically finding, classifying, and taking corrective actions against counterfeit products and/or fake assets online may be implemented, according to an example embodiment.

FIG. 2 is an illustration of a detailed method of automatically finding, classifying, and taking corrective actions against counterfeit products and/or fake assets online with respect to an enterprise, performed primarily by a management system of the network environment, according to an example embodiment.

FIG. 3 is a flowchart of a high-level method of automatically finding, classifying, and taking corrective actions against counterfeit products and/or fake assets online with respect to an enterprise, performed primarily by the management system, according to an example embodiment.

FIG. 4 is a block diagram of a computer device representative of the management system, according to an example embodiment.

FIG. 5 is an illustration of machine learning (ML) operations performed in connection with an ML classifier of the management system.

### DESCRIPTION OF EXAMPLE EMBODIMENTS

### Overview

A method is performed by a management system configured to communicate with one or more networks. The method includes performing a focused search to find uniform resource identifiers (URIs) of potentially counterfeit products and/or fake assets online based on brand assets terms associated with an enterprise, and performing a search for adjacencies of blacklist URIs of counterfeit products and/or fake assets online to find additional URIs of potentially counterfeit products and/or fake assets online that are related to the blacklist URIs. The method also includes adding the URIs and the additional URIs to a URI list, and classifying, by a machine learning classifier, each URI on the URI list as one of a blacklist URI of counterfeit products and/or fake assets online, and a whitelist URI of authentic products and/or assets online that are not counterfeit or fake. The method also includes repeating (i) the performing the search for adjacencies using blacklist URIs resulting from the classifying, (ii) the adding, and (iii) the classifying, to cause the URI list, a number of blacklist URIs, and a number of whitelist URIs to expand from the repeating, and removing access to counterfeit and/or fake assets online revealed by the focused search, the search for adjacencies, or the classifying.

### Example Embodiments

The sale of counterfeit products online costs enterprises over $300 B annually. Products such as medicines, luxury goods, and hardware are heavily counterfeited online, making this an urgent topic for several industries. This problem damages enterprises at multiple levels. It not only impacts their sales and revenues but also affects their brand and customer relationships. In segments such as pharma or hardware, counterfeit products sold online can cause health and safety issues, with negative connotations for the brands. As an example, only during their last fiscal year, Novartis (pharma) took down more than 7,000 websites, including impersonated pharmacies as well as ecommerce sites selling counterfeit medicines. Conventional techniques to combat counterfeit products online heavily depend on manual intervention, which is slow and costly. This is due to the absence of truly automated solutions capable of searching, classifying and taking actions against counterfeit products and/or fake assets online.

These problems are becoming much bigger with the malicious use of artificial intelligence (AI) and automated attacks. Advances in Natural Language Processing (NLP) are particularly concerning, since they allow targeting consumers individually, by using personalized messages via social networks, search engines or emails. Advances on this front not only facilitate the creation of counterfeit offerings and fake assets online, but also allow fraudulent actions to scale out. Indeed, one of the reasons why conventional techniques to combat such counterfeiting are often ineffective and require manual intervention is because perpetrators rapidly move their counterfeit sites and/or products to a new online domain using automated mechanisms.

Conventional techniques lack mechanisms to correlate specific content and associate that content to the sale of the same counterfeit products online. Thus, if an enterprise is able to detect a counterfeit product online, instead of activating a procedure to taking it down immediately, manual processes are triggered to gather information about the sellers, correlate them with other websites and offerings online with the hope of preventing future frauds from the same sources. This process uses tedious, slow, and heavily manual investigations before taking any action.

Solutions in this technology space can be grouped roughly into the following four categories:
a. Investigation teams that manually discover domains selling counterfeit products on the Internet using search engines. Such discovery is driven by heavily manual processes that search for indicators such as the price tag of a product on sale and/or the appearance of an e-commerce site to identify counterfeit products. Upon detection of fake products and/or domains, the enterprise affected issues a request to domain registrars and/or e-commerce sites to takedown the offending website and/or the products sold online. This process often entails manual operations which are time consuming. Their effectiveness is also an issue. For example, Black hat operators simply move their counterfeit websites and/or products to a new domain and resume their fraudulent activities, thereby requiring new manual searches and discovery efforts. Thus, the investigation team approach just described is essentially ineffective for repeat offenders.
b. Online platforms that provide information to potential consumers regarding the trustworthiness of a domain. Some of these platforms also offer browser plug-ins. Such platforms often rely on user-provided reviews along with analytics on the domain under consideration to provide consumers with trustworthy ratings; however, these platforms suffer from several drawbacks. First, they lack a systematic approach to find potentially new domains that are only active for a few days. Second, they depend on proactive participation of consumers to be able to assess the trustworthiness of a domain. Finally, they are unable to take down counterfeit products sold by Black hat vendors on well-known domains, such as Amazon, since this goes beyond their scope.
c. Some enterprises, such as Red Points (https://www.redpoints.com/technology/) and Mark Monitor (https://www.markmonitor.com/), offer solutions that fall short in at least the following aspects:
   i. They do not perform focused searches leveraging data and insights combining spam email, Black hat search engine optimizations, targeted social media sites and messages, and the like, which are commonly used to disseminate the location of counterfeit products and/or fake assets online.
   ii. They do not find adjacencies for counterfeits leveraging network threat intelligence data (e.g., Domain Name System (DNS) related data, metadata and insights, search engine optimization techniques and backlink exploration, time and event correlation related to domains, and so on).
   iii. They do not provide methods to automate the takedown of fraudulent/counterfeit sites, domains and webpages.
   iv. They do not use network threat data to complement web crawling data, which improves the performance of network classifiers.
   v. They do not combine artificial intelligence (AI)/machine learning (ML) (collectively referred to herein as “machine learning” or “ML”) and system wide network threat intelligence data to enable an enterprise to automatically take actions against counterfeit products and/or fake assets associated to them.

Accordingly, embodiments presented herein include techniques to automatically find, classify, and take action against counterfeit products and/or fake assets online that overcome the above mentioned problems and disadvantages associated with conventional techniques, and that offer advantages over the conventional techniques. To this end, the techniques presented herein combine machine learning and system wide network threat intelligence data to: automatically perform a focused search to find potential counterfeit products and/or fake assets online; automatically analyze and classify the findings of the focused search, and discover new adjacencies (i.e., new potential threats based on the findings); and automatically take actions to bring down or otherwise deny (i.e., remover or block) access to the counterfeit products and/or fake assets online. The term “online” is generally understood to mean accessible, or performed, over one or more communication networks, including, e.g., the Internet.

The techniques employ a focused search. The focused search finds potential counterfeits by starting a search from the communication channels usually used to attract potential consumers (e.g., spam email, Black hat search engine optimization techniques, targeted social media sites and messages, and the like). This can be enabled through the use of threat intelligence data (e.g., DNS related domain data and metadata, search engine optimization techniques and backlink exploration, and time and event correlation related to domains), which is collected from multiple sources and networks and aggregated at a system level (e.g., such as the data available through a threat intelligence platform, by Cisco). The search is expanded and complemented through the use of traditional search platforms (e.g., Google, Bing, and the like) and web crawling techniques.

Following the focused search, the techniques also analyze and classify findings of the focused search, and discover new adjacencies, which represent additional findings related to the findings of the focused search. To do this, the techniques gather or otherwise accesses network threat intelligence data and leverage that data both for steering the focused search as well discovering new adjacencies. Reciprocally, threat intelligence data stores can be expanded as a result of analysis and discovery of new webpages that represent adjacencies and new data specifically related to counterfeit products and/or fake assets online.

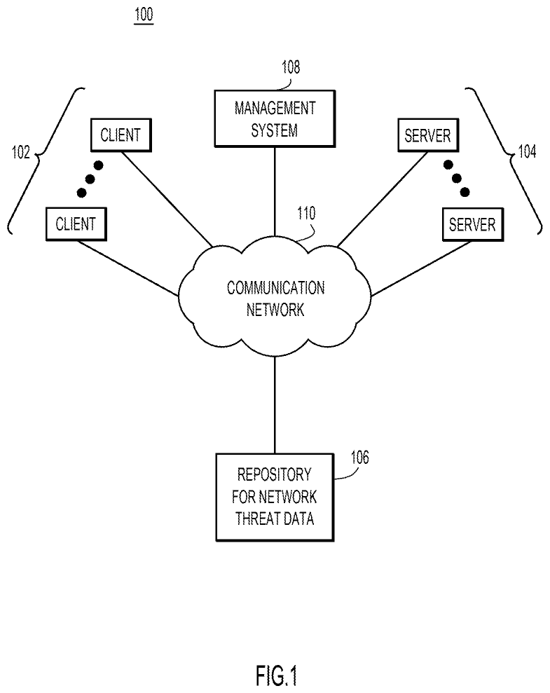

Referring first to FIG. 1, there is shown a block diagram of an example network environment 100 in which embodiments directed to automatically finding, classifying, and taking corrective action against counterfeit products and/or fake assets online (also referred to as “online counterfeit products and/or fake assets”) may be implemented. Environment 100 includes client devices 102 (also referred to as “clients” 102), server devices 104 (also referred to as “servers” 104), a cloud-based repository 106 configured with known threat data, and a cloud-based management system 108 each connected to a communication network 110. Repository 106 may include one or more servers configured to store the known/predetermined network threat data and also known trusted network data. Communication network 110 may include one or more local area networks (LANs) and one or more wide area networks (WANs), such as the Internet. Clients 102, servers 104, management system 108, and repository 106 may communicate with each other over network 110 using any known communication protocol, such as the suite of Internet protocols, including the Transmission Control Protocol (TCP), the Internet Protocol (IP), and the Hypertext Transfer Protocol (HTTP). For example, clients 102, servers 104, management system 108, and repository 106 may exchange messages and data with each other in the form of IP packets in order to implement techniques presented herein.

Clients 102 and servers 104 connect with each other over network 110, and then typical network traffic flows between the endpoints. For example, responsive to requests from clients 102, servers 104 may transfer data stored locally at the servers to the clients over network 110, as is known. Servers 104 typically transfer data to clients 102 as sequences of data packets, e.g., IP packets. Management system 108 may connect with clients 102 and/or servers 104 through network 110. Management system 108 may take on a variety of forms, including that of client device, a server device, a network router, or a network switch configured with computer, storage, and network resources sufficient to implement the techniques presented herein.

Authentic enterprises (i.e., trusted, genuine enterprises that are not bad actors) may own and/or operate various ones of servers 104, and may host on those servers their authentic (i.e., genuine) products and/or assets online (also referred to as “online products and/or assets”) that are not counterfeit and/or fake. “Assets” may include websites, webpages, names of executives/managers of an enterprise (e.g., a fake John Doe facebook profile), look-alike website names (e.g., “authenticairjordan.com”), media files, marketing collaterals, software files/executables, and the like. Consumers may invoke standard browsers hosted on clients 102 to perform online searches for and to access the authentic products and/or assets online hosted on servers 104 over network 110. On the other hand, bad actors, such as counterfeiters, may orchestrate deployment of counterfeit products and/or fake assets online on other ones of servers 104. Consumers may also access the counterfeit products and/or fake assets online over network 110 via clients 102. Often, the consumers cannot differentiate between the authentic products and/or assets online and the counterfeit products and/or fake assets online. Management system 108 primarily interacts with repository 106 and network 110 to automatically find, classify, and take corrective actions against the counterfeit products and/or fake assets online that are hosted on the above-mentioned servers, for example, as described above and further below.

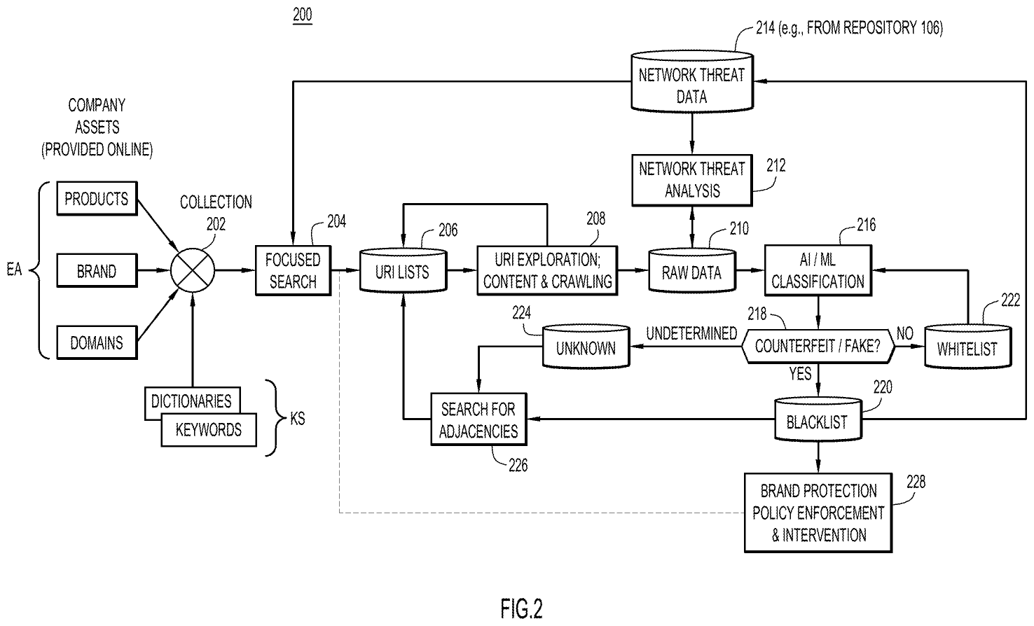

With reference to FIG. 2, there is an illustration of an example method 200 of automatically finding, classifying, and taking corrective actions against counterfeit products and/or fake assets online with respect to an enterprise, e.g., a company, an organization, or an individual, performed primarily by management system 108. It is assumed that the enterprise possesses or owns various (authentic) enterprise assets EA associated with the enterprise. Enterprise assets EA include (i) products that the enterprise sells, leases, licenses, and so on, online, (ii) brands/brand names associated with the enterprise and that are presented online, and (iii) domains (e.g., domain names) associated with the enterprise and used to identify and access the products and/or assets online. Any and all of enterprise assets EA represent potential targets of counterfeit products and/or fake assets online. It is also assumed that method 200 has access to a keyword store KS that includes a set of keywords and relevant dictionaries, which may be employed to generate search terms. Example of keywords may include “buy,” cheap,” “best price,” and the like. Even further, method 200 has access the known/predetermined network threat data stored in repository 106. The network threat data is shown at 214 in FIG. 2.

At 202, information to be used in a focused search (described below) is collected. The information includes brand asset terms relevant to the enterprise. The brand asset terms may be collected in an automated manner, e.g. by integrating with software products for Enterprise Resource Planning (ERP)/Customer Relationship Management (CRM), and scraping authentic domains. Also, the brand asset terms may be collected and entered manually, e.g., using a graphical user interface (GUI) by which an administrator of management system 108 may enter the brand asset terms. Examples of brand asset terms include product names (e.g., Cisco Meraki), brand names (e.g., Ralph Lauren, which is a brand name relevant to the L'Oreal group), and domain names (e.g., https://www.ralphlauren.es/en). The information collected at 202 also includes the set of keywords and the relevant dictionaries from keyword store KS. The information collected at 202 may be formatted as an information matrix (e.g., a one-dimensional, two-dimensional, or three-dimensional matrix) for presentation/input to next operation 204.

At 204, a focused search on the information collected at 202, i.e., the brand asset terms relevant to the enterprise, the set of keywords, and the relevant dictionaries, is performed. In an example, the focused search may include a search on/over a network, i.e., the focused search may include an online focused search. The focused search finds/detects uniform resource identifiers (URIs) of potentially counterfeit and/or fake assets online. As used herein, the term URI refers to, for example, an identifier of a resource accessible over a network. Examples of URIs include, but are not limited to, domain names, uniform resource locators (URLs), webpages served on the World Wide Web (WWW), or product pages of specific e-commerce platforms, such as Amazon.com. The URIs found by the focused search are stored/added in/to a URI list 206 for subsequent processing. At a high-level, the focused search searches through mechanisms and channels commonly used between consumers and counterfeiters to attract the consumers online, which mechanisms and channels may be accessible in network threat data 214, for example. Examples include data from spam email, search engine results generated using Black hat search engine optimization techniques, targeted social media posts, marketplace search application programming interfaces (APIs), and so on. Thus, the focused search is performed not only on traditional search engines such as Google or Bing, but also using network threat data 214 (e.g., which stores spam email lists or phishing website lists). The focused search may use any of a plurality of methods including indexing spam email, social media search, and so on.

More specifically, the focused search may include (i) search engine optimization, (ii) social media Bot detection, and (iii) an NLP-derived dictionary, each described below. Other channels, such as spam emails or phishing website-lists can be combined with techniques (i), (ii), and (iii). A Bot (e.g., an “Internet Bot” or “web robot”) is an autonomous software application that runs automated tasks over a network, e.g., the Internet, as is known.

An example of the search engine optimization may include the following sequence of operations:
a. Use traditional search engine optimization (SEO) keyword tools to find search engine keywords that are relevant to the brand assets terms.
b. Optimize and extend the search engine keywords and keywords in the set of keywords (e.g., from keyword store KS) using additional techniques that are particularly designed to find counterfeit domains (e.g., extend the keyword “Buy Ralph Lauren online” to “Buy Cheap Ralph Lauren Online,” as well as minor mutations of domain names, such as https://www.ralph-lauren.es/en). Several methods may be used to perform such keyword extensions. For example, one method uses a small dictionary of extension vocabulary with words such as “Fake,” “Cheap,” “rip-off,” and the like, in the dictionary, and simply appends these dictionary words to the SEO keywords. More advanced ML techniques can also be used to autogenerate the extended keywords.
c. The SEO optimised and extended keywords are then used as search terms in traditional search engines. The results obtained by the traditional search engines are stored in a database. The results can be obtained using several techniques: 1) manually; 2) using web scrapers, using any known or hereafter developed web scrapers (e.g., as presented at http://www.scrapebox.com/search-engine-scraper); and 3) using the APIs provided by search vendors, which include any known or hereafter developed APIs (e.g., as presented at https://azure.microsoft.com/en-us/services/cognitive-services/ and https://cse.google.com/cse/all).
d. The URIs (e.g., URLs) provided by the traditional search engines are crawled recursively (e.g., by following web-redirection URLs, links embedded in pages, and so on, to find URLs).
e. The URIs (e.g., URLs) obtained in (d) are presented as results to the focused search.

An example of social media Bot detection may include the following sequence of operations:
a. Collect #hashtags relevant to the brand asset terms.
b. Search for brand assets terms (including minor mutations of domain names, such as https://www.ralph-lauren.es/en) and #hashtags on social media posts, and collect lists of users that may have posted any content on the relevant terms or #hashtags. This search may be performed using web crawling techniques and/or APIs provided by social media platforms, using any known or hereafter developed APIs (e.g., as presented at https://developer.twitter.com/en/docs.html).
c. Use social media Bot detection methods to find social media Bots among the list of users from (b). Any known or hereafter developed Bot detection technique may be employed in this operation (e.g., as presented at https://cacm.acm. org/magazines/2016/7/204021-the-rise-of-social-bots/fulltext).
d. Collect all URLs and links posted by Bots detected in (c).

e. Recursively crawl links from (d) (e.g., by following web-redirection URLs, links embedded in pages, and so on) to find additional URLs.
f. The URLs obtained in (e) are appended to the results of the focused search produced by the SEO described above.

An example of the NLP-derived dictionary includes applying NLP-based tokenization of an enterprise's digital assets (e.g., finding common nouns and proper nouns within the authentic marketing website) to create a dictionary of keywords that are used as seeds for the above-described social media Bot detection.

At 208, URI exploration is performed. To do this, the URIs in URI list 206 identified by the focused search are explored and data is collected from the URIs (e.g., by web crawling the URIs using web crawlers or through the APIs provided by marketplaces). The exploration of the URIs may lead to additional URIs of potentially counterfeit and/or fake assets that need to be explored further. The additional URIs are also stored in URI list 206 to expand the URI list. Raw data collected from URI exploration, including the additional URIs, as well as other data, such as metadata, indexes, and so on, is stored in a raw data database 210, for subsequent processing.

At 212, the raw data stored in raw data database 210 is complemented with additional data produced by network threat analysis. The network threat analysis operates on network threat data 214. For example, the network threat analysis produces data that includes DNS registration/query information, matching of URIs in spam emails, and so on, that enhances the raw data from 208.

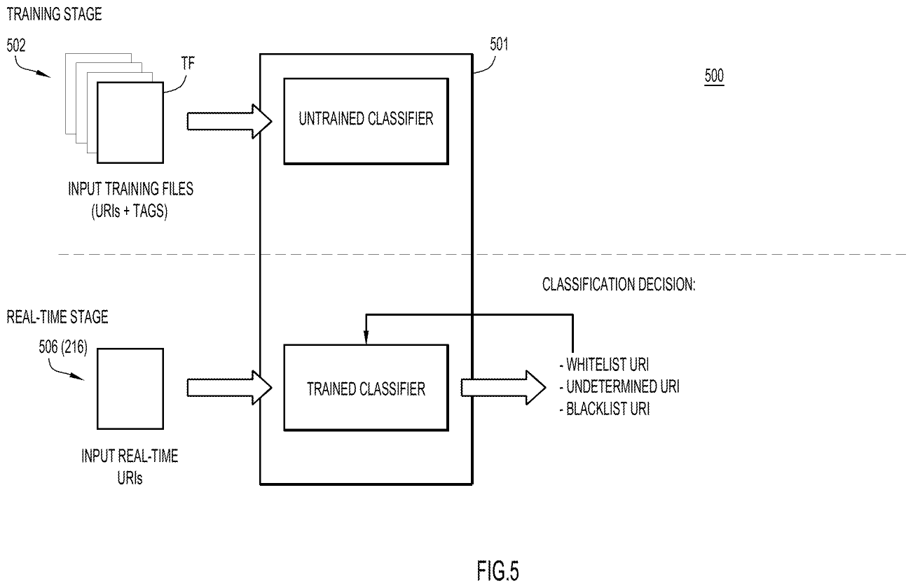

At 216, an ML classifier classifies each URI on URI list 206, complemented with the raw data of raw database 210, as one of: (i) a URI of counterfeit products and/or fake assets online, referred to as a blacklist URI; (ii) a URI of authentic products and/or assets online that are not counterfeit or fake, referred to as a whitelist URI; and (iii) a URI of products and/or assets online that the ML classifier is unable to classify as either a blacklist URI or a whitelist URI due to lack of classifying information/knowledge with respect to the URI, referred to as an “undetermined URI” or a URI having an unknown status, for which further analysis is needed. An example ML classifier is described below in connection with FIG. 5.

It is assumed that the ML classifier is trained initially in an a priori training stage, i.e., prior to operation 216. In the a priori training stage, training data is supplied to inputs of the ML classifier to train the ML classifier. The training data typically includes labels derived from URIs of authentic products and/or assets online associated with respective indicators/tags to indicate authenticity, and labels derived from URIs of counterfeit products and/or assets online associated with indicators/tags to indicate counterfeit or fake status. After the a priori training stage, during runtime/real-time classifying at 216, the ML classifier employs supervised learning using feedback of the whitelist URIs that result from classifying at 216 as training labels.

Examples of ML classifiers that may be trained for use in classifying at 216 include individual URI classifiers, and network clustering classifiers. Individual URL classifiers take as input a single URL and produce an output that can be interpreted as a probability that the URL aims to sell a counterfeit product and/or fake asset. The URLs provided as input to these classifiers are provided as output from the focused search at 204, a search for adjacencies (operation 226, described below), and the recursive web crawling at 208. Features that may be extracted from the input URIs, and that form the basis for classifying the URIs, include items such as images on a webpage indicated by the URI, price lists, DNS data for webpages including authorization and query logs, and so on. These classifiers may use any known or hereafter developed ML algorithm to classify the URIs, including logistic regression, support vector machines, decision trees, and so on.

On the other hand, network clustering classifiers take as input a set of (potentially suspicious) URIs and output indicator that the URIs belong to one or more clusters operated by the same counterfeiter (e.g., given a set of social media Bots, the classification can determine if a subset of these Bots belong to the same agent). The inputs to these classifiers include the output of the individual URI classifier described above, and the search for adjacencies mentioned above. Examples of such classifiers include nearest neighbor classifiers (e.g., that use locally-sensitive hashing), unsupervised clustering (e.g. K-means), maximal subsequence matching algorithms, and so on.

At 218, it is determined whether the ML classifier classified the URI presented at the input to the classifier as a blacklist URI, a whitelist URI, or an undetermined URI. When/if it is determined that the URI is a blacklist URI, a whitelist URI, or an undetermined URI, the URI is stored in a blacklist 220 of URIs classified as blacklist URIs, a whitelist 222 of URIs classified as whitelist URIs, or an undetermined/unknown list 224 of URIs which the classifier was unable to classify as either a blacklist URI or a whitelist URI, respectively, for subsequent processing.

The output of the ML classifier, i.e., classification decisions, are used take one or more of four possible actions:
a. Search for adjacencies performed based on the blacklist URIs and the undetermined URIs (operation 226, described below). The adjacencies represent potentially counterfeit products and/or assets related to/derived from the blacklist URIs and the undetermined URIs. As described below, the search for adjacencies uses network data to find websites similar to those on the blacklist, and uses the found websites to identify additional domains that are offering potentially counterfeit products and/or fake assets. Examples include looking through DNS authorization logs to find all domains being served from the same IP address as a blacklist domain, or using DNS query logs to find domains visited by a user in quick succession.
b. Whitelist ML feedback. Whitelist URIs are fed-back to a supervised learning input of the ML classifier and used by the ML classifier as supervised labels for future classifications.
c. Blacklist network threat feedback. Blacklist URIs are fed back as updates to network threat data 214.
d. Intervention based on blacklist 220 is performed (“Brand Protection, Policy Enforcement, and Intervention” operation 228, described below).

At 226, the above-mentioned search for adjacencies is performed. In an example, the search for adjacencies may include a search that is performed on/over a network, i.e., the search for adjacencies may include an online search for adjacencies. The search for adjacencies searches the blacklist URIs and the undetermined URIs to find additional URIs of potentially counterfeit products and/or fake assets online that are related to the blacklist URIs and the undetermined URIs. The search for adjacencies also finds network relationships between multiple nodes that belong to the same counterfeiter, so that this found “network of the counterfeiter's URIs” may be blocked/stopped instead of having to block many counterfeiting URIs individually. The additional URIs (i.e., adjacencies) found by the search for adjacencies are added to URI list 206 to expand the URIs that are to be subjected to the (ML) classifying at 216.

As shown in FIG. 2, method 200 includes an automatically repeating loop. The repeating loop includes: classifying the URIs (216); the search for adjacencies (226), i.e., searching the blacklist URIs and the undetermined URIs resulting from the classifying for adjacencies; adding the found adjacencies to URI list 206 to complement the URIs from the focused search; URI exploration/web crawling and adding of the URIs found thereby to the URI list (208). In each iteration of the repeating loop, the repeating loop adds URIs found in the search for adjacencies (226) and URIs found in the URI exploration (208) to URI list 206 presented to the ML classifier (216). Thus, the repeating loop results in automatically expanding the number of URIs of potentially counterfeit and/or fake assets on the URI list beyond those found in the focused search and, correspondingly, the number of URIs that are classified over time, i.e., in each successive iteration of the repeating loop. Also, the repeating loop improves the accuracy and quality of the classifying over time, due to the feedback of whitelist URIs to the supervised training input of the ML classifier.

The search for adjacencies may include searches for backlink-based adjacencies and DNS based adjacencies. A search for backlink-based adjacencies includes the following operations:
a. Collect a list of domains (e.g., domain names) selling/advertising counterfeit products and/or fake assets.
b. Use this list of domains to generate new domains according by the following method:
   i. Collect a list of backlinks to these domains, using any known or hereafter developed technique for collecting backlinks (e.g., as presented at https://en.wikipedia.org/wiki/Backlink). A backlink for a given website is a link from some other website (the referrer) to that website, i.e., an incoming/inbound link to the given website. Increasing backlinks from manipulated domains is a standard Black hat SEO tool that increases performance in search engines. The backlinks can be collected by producing a general index on websites or by using a backlink API, which may be any known or hereafter developed backlink API (e.g., as presented at https://moz.com/learn/seo/backlinks).
   ii. Crawl the domains obtained from the collected backlinks to find other domains that might be selling counterfeit products and/or fake assets. The web crawling method relies on the fact that several counterfeit product and/or fake assets vendors may use the same affiliate networks to achieve SEO. Therefore, if one domain is found, then it is expected that the backlink <-> forward-link method will allow the other domains that sell counterfeit products also to be found.

A search for DNS-based adjacencies includes the following operations:
a. Collect/identify a list of domains selling counterfeit products and/or fake assets.
b. Using this list of domains generate new domains using the following methods:
   i. Find all other domains that are being served by the IP address(es) that is(are) serving this domain.
   ii. Find all other domains that are registered with the same name server.
   iii. Use algorithms to generate new domain names similar to those found in (ii). Any known or hereafter developed algorithm may be used in this operation, such as “DNS twist” (e.g., as presented at https://github.com/elceef/dnstwist).
   iv. Use character-level (Char) recurrent neural network (RNN) networks trained on the domain URIs to generate potentially new URIs (e.g., as presented at https://github.com/karpathy/char-rnn).
c. Perform DNS queries against the domains in the list from (b) to determine whether there are domains associated with (e.g., selling) potentially counterfeit products and/or fake assets online and, if so, use the domains as additional URIs for URI list 206.
d. Use DNS authoritative logs/query logs to determine whether the domains from the list from (b) are registered and/or queried by users for the first time.
e. Provide a list of potential counterfeit domains from steps (b), (c), and (d).

At 228, automated intervention is performed based on the blacklist URIs accessed in blacklist 220. Such intervention removes or blocks online access to the blacklist URIs, which prevents the sale of counterfeit products and fake advertising, for example. Several possible methods of intervention may be used, including domain takedowns, payment notifications, DNS and web filtering, and so on. Also, a message may be sent to an administrator of management system 108 indicating the blacklist URIs, for display on a GUI at the management system. Successful intervention makes blacklist URIs no longer accessible online at a later stage in time, which also changes the results of the focused search, e.g., the blacklist URIs subject to successful intervention may be removed from URI list 206 (if a search of the URI list finds such blacklist URIs in the URI list) (indicated in FIG. 2 by the dashed-line connecting the search for adjacencies (226) to an input of the focused search (204)).

Method 200 includes a second automatically repeating loop, including the following operations: classifying 216; feedback of blacklist URIs to network threat data 214; and network threat analysis 212 feeding data to raw data database 210 to compliment the URIs from URI list 206 then presented to classifying 216. The second automatically repeating loop expands and refines network thread data 214 and network threat analysis 212, to produce more accurate information to the classifying. The automatically repeating loop that incorporates the search for adjacencies 226 and the second automatically repeating loop together represent interrelated automatically repeating loops that enable two different counterfeit and threat analysis to work in concert, to improve automatically finding, classifying, and taking corrective action against counterfeit products and/or fake assets online. Thus method 200 represents a closed-loop method that incorporates multiple repeating loops that improve outcomes.

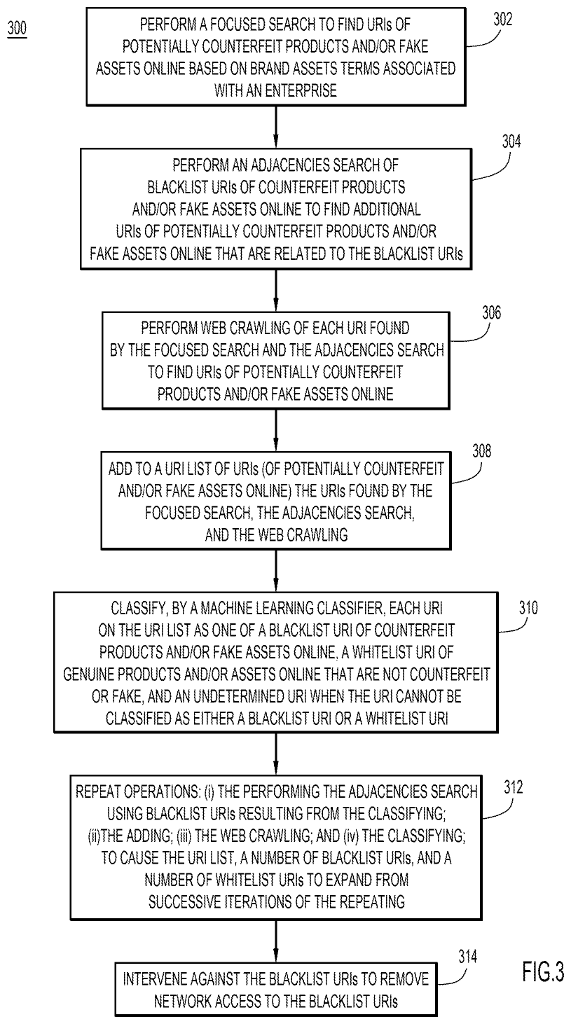

With reference to FIG. 3, there is a flowchart of an example high-level method 300 of automatically finding, classifying, and taking corrective actions against counterfeit products and/or fake assets online with respect to an enterprise, performed primarily by management system 108. Method 300 incorporates operations described above in connection with FIG. 2. The operations of method 300 may be performed without manual intervention.

At 302, management system (MS) 108 automatically collects brand assets terms associated with an enterprise, and performs a focused search to find URIs of potentially counterfeit products and/or fake assets online based on the brand assets terms.

At 304, MS 108 performs a search for adjacencies (also referred to as an “adjacencies search”) of blacklist URIs of counterfeit products and/or fake assets online to find additional URIs of potentially counterfeit products and/or fake assets online that are related to the blacklist URIs.

At 306, MS 108 performs online web crawling of each URI found by the focused search and the search for adjacencies to find URIs of potentially counterfeit products and/or fake assets online.

At 308, MS 108 adds to a URI list of URIs (of potentially counterfeit and/or fake assets online) the URIs found by the focused search, the search for adjacencies, and the online web crawling.

At 310, MS 108 classifies, by a machine learning classifier, each URI on the URI list as one of a blacklist URI of counterfeit products and/or fake assets online, a whitelist URI of authentic products and/or assets online that are not counterfeit or fake, and an undetermined URI when the URI cannot be classified as either a blacklist URI or a whitelist URI. The whitelist URI is fed-back to a supervised training input of the ML classifier, to train the ML classifier.

At 312, MS 108 automatically repeats operations: (i) the performing the search for adjacencies using blacklist URIs resulting from the classifying; (ii) the adding; (iii) the online web crawling; and (iv) the classifying; to cause the URI list, a number of blacklist URIs, and a number of whitelist URIs to expand as a result of successive iterations of the repeating.

At 314, MS 108 automatically removes access to counterfeit and/or fake assets online found by the focused search, found by the search for adjacencies, or identified by the classifying (i.e., revealed by the aforementioned operations). For example, MS 108 automatically intervenes against the blacklist URIs to remove network access to the blacklist URIs.

MS 108 repeats the operations of method 300.

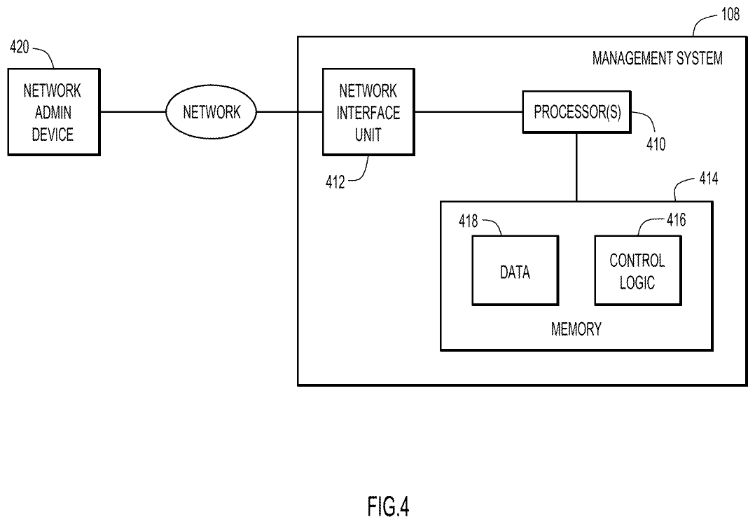

With reference to FIG. 4, there is shown a hardware block diagram for management system 108. In an example, management system 108 includes a computer system, such as a server, having one or more processors 410, a network interface unit (NIU) 412, and a memory 414. Memory 414 stores control software 416 (referred as “control logic”), that when executed by the processor(s) 410, causes the computer system to perform the various operations described herein for management system 108.

The processor(s) 410 may be a microprocessor or microcontroller (or multiple instances of such components). The NIU 412 enables management system 108 to communicate over wired connections or wirelessly with a network. NIU 412 may include, for example, an Ethernet card or other interface device having a connection port, which enables management system 108 to communicate over the network via the connection port. In a wireless embodiment, NIU 412 includes a wireless transceiver and an antenna to transmit and receive wireless communication signals to and from the network.

The memory 414 may include read only memory (ROM), random access memory (RAM), magnetic disk storage media devices, optical storage media devices, flash memory devices, electrical, optical, or other physically tangible (i.e., non-transitory) memory storage devices. Thus, in general, the memory 414 may comprise one or more tangible (non-transitory) computer readable storage medium/media (e.g., memory device(s)) encoded with software or firmware that comprises computer executable instructions. For example, control software 416 includes logic to implement methods/operations relative to management system 108, and logic to implement an ML classifier as described herein, such as methods 200 and 300. Thus, control software 416 implements the various methods/operations described above. Control software 416 also includes logic to implement/generate for display GUIs in connection with the above described methods/operations. Memory 414 also stores data 418 generated and used by control software 416, such as blacklists, whitelists, a URI list, keywords and dictionaries, raw data, network threat data, and GUI information as described herein.

A user, such as a network administrator, may interact with management system 108, to display indications and receive input, and so on, through GUIs by way of a user device 420 (also referred to as a “network administration device”) that connects by way of a network with management system 108. The user device 420 may be a personal computer (laptop, desktop), tablet computer, SmartPhone, etc., with user input and output devices, such as a display, keyboard, mouse, and so on. Alternatively, the functionality and a display associated with user device 420 may be provided local to or integrated with management system 108.

With reference to FIG. 5, there is an illustration of example machine learning (ML) operations 500 used by management system 108 before and during method 200. Operations 500 are performed in connection with an ML classifier 501 used to classify URIs. Operations 500 include an a priori training stage 502 to train ML classifier 501 to classify URIs, and a real-time stage 506 that uses the trained ML classifier to classify URIs at run-time, as described above.

At 502, training files TF are provided to a training input of ML classifier 501 in its untrained state. The training files TF may include a variety of training labels. The training labels include (i) artificial and/or actual URIs of genuine products and/or assets online along with associated indicators/tags that identify the URIs as genuine, and (ii) artificial and/or actual URIs of counterfeit products and/or fake assets online along with associated indicators/tags that identify the URIs as counterfeit. ML classifier 501 trains on the training files TF to recognize the URIs as either genuine or counterfeit.

At 506, (corresponding to classifying operation 216 described above) real-time URIs from the repeating loops of method 200 (and 300) are provided to ML classifier 501 that was trained at 502. Trained ML classifier 501 makes classification decisions to classify each URI as one of a blacklist URI, a whitelist URI, or an undetermined URI. Each whitelist URIs is fed-back to a supervised training input of ML classifier 501 to train the ML classifier during run-time.

In summary, presented herein are techniques directed to automatically finding, classifying, and taking corrective actions against counterfeit products and/or fake assets online. The techniques combine online data collection using focused search of attack vectors used to distribute attach vectors used to distribute information regarding and advertising counterfeit products, network threat (intelligence) data, and machine learning algorithms to perform detection, and take-action against the advertisement and sale of counterfeit products and other fake assets online, that may be discovered on websites, marketplaces, the dark web, social sites, phishing and spam email lists, and so on, by the techniques presented herein.

In summary, in one form, a method is provided comprising: at a management system configured to communicate with one or more networks: performing a focused search to find uniform resource identifiers (URIs) of potentially counterfeit products and/or fake assets online based on brand assets terms associated with an enterprise; performing a search for adjacencies of blacklist URIs of counterfeit products and/or fake assets online to find additional URIs of potentially counterfeit products and/or fake assets online that are related to the blacklist URIs; adding the URIs and the additional URIs to a URI list; classifying, by a machine learning classifier, each URI on the URI list as one of a blacklist URI of counterfeit products and/or fake assets online, and a whitelist URI of authentic products and/or assets online that are not counterfeit or fake; repeating (i) the performing the search for adjacencies using blacklist URIs resulting from the classifying, (ii) the adding, and (iii) the classifying, to cause the URI list, a number of blacklist URIs, and a number of whitelist URIs to expand from the repeating; and removing access to counterfeit and/or fake assets online revealed by the focused search, the search for adjacencies, or the classifying.

In another form, an apparatus is provided comprising: a network interface unit to communicate with a network; and a processor coupled to the network interface unit and configured to perform: performing a focused search to find uniform resource identifiers (URIs) of potentially counterfeit products and/or fake assets online based on brand assets terms associated with an enterprise; performing a search for adjacencies of blacklist URIs of counterfeit products and/or fake assets online to find additional URIs of potentially counterfeit products and/or fake assets online that are related to the blacklist URIs; adding the URIs and the additional URIs to a URI list; classifying, by a machine learning classifier, each URI on the URI list as one of a blacklist URI of counterfeit products and/or fake assets online, and a whitelist URI of authentic products and/or assets online that are not counterfeit or fake; repeating (i) the performing the search for adjacencies using blacklist URIs resulting from the classifying, (ii) the adding, and (iii) the classifying, to cause the URI list, a number of blacklist URIs, and a number of whitelist URIs to expand from the repeating; and removing access to counterfeit and/or fake assets online revealed by the focused search, the search for adjacencies, or the classifying.

In a further form, a non-transitory computer readable storage medium is provided. The computer readable medium is encoded with instructions, that when executed by a processor, are operable to perform performing a focused search to find uniform resource identifiers (URIs) of potentially counterfeit products and/or fake assets online based on brand assets terms associated with an enterprise; performing a search for adjacencies of blacklist URIs of counterfeit products and/or fake assets online to find additional URIs of potentially counterfeit products and/or fake assets online that are related to the blacklist URIs; adding the URIs and the additional URIs to a URI list; classifying, by a machine learning classifier, each URI on the URI list as one of a blacklist URI of counterfeit products and/or fake assets online, and a whitelist URI of authentic products and/or assets online that are not counterfeit or fake; repeating (i) the performing the search for adjacencies using blacklist URIs resulting from the classifying, (ii) the adding, and (iii) the classifying, to cause the URI list, a number of blacklist URIs, and a number of whitelist URIs to expand from the repeating; and removing access to counterfeit and/or fake assets online revealed by the focused search, the search for adjacencies, or the classifying.

Although the techniques are illustrated and described herein as embodied in one or more specific examples, it is nevertheless not intended to be limited to the details shown, since various modifications and structural changes may be made within the scope and range of equivalents of the claim.

What is claimed is:

1. A computer implemented method comprising:
at a management system configured to communicate with one or more networks:
performing a focused search to find uniform resource identifiers (URIs) of potentially counterfeit products and/or fake assets online based on brand assets terms associated with an enterprise;
performing a search for adjacencies of blacklist URIs of counterfeit products and/or fake assets online to find additional URIs of potentially counterfeit products and/or fake assets online that are related to the blacklist URIs;
adding the URIs and the additional URIs to a URI list;
classifying, by a machine learning classifier, each URI on the URI list as one of a blacklist URI of counterfeit products and/or fake assets online, and a whitelist URI of authentic products and/or assets online that are not counterfeit or fake;
repeating (i) the performing the search for adjacencies using blacklist URIs resulting from the classifying, (ii) the adding, and (iii) the classifying, to cause the URI list, a number of blacklist URIs, and a number of whitelist URIs to expand from the repeating; and
removing access to counterfeit and/or fake assets online revealed by the focused search, the search for adjacencies, or the classifying.

2. The method of claim 1, wherein:
the classifying further includes classifying each URI on the URI list as an undetermined URI of products and/or assets online when the classifying is unable to classify the URI as either a blacklist URI or a whitelist URI; and
the performing the search for adjacencies further includes performing the search for adjacencies of undetermined URIs resulting from the classifying to identify additional URIs of potentially counterfeit products and/or fake assets online to be added to the URI list for the classifying.

3. The method of claim 1, further comprising:
performing web crawling of each URI found by the focused search and the search for adjacencies; and
adding the URIs resulting from the web crawling to the URI list, such that the classifying includes classifying each URI resulting from the focused search, the search for adjacencies, and the web crawling.

4. The method of claim 1, further comprising:
providing whitelist URIs resulting from the classifying to a supervised learning input of the machine learning classifier to train the machine learning classifier.

5. The method of claim 1, wherein the performing the search for adjacencies includes:
discovering backlinks associated with each blacklist URI, and using the backlinks as at least some of the additional URIs.

6. The method of claim 1, wherein the performing the search for adjacencies includes:
identifying a list of domains that are selling counterfeit products and/or fake assets online based on the blacklist URIs;
generating new domains from the list of domains;
performing domain name system (DNS) queries against the new domains; and
determining whether the new domains are associated with potentially counterfeit products and/or asset, and if the new domains are associated with potentially counterfeit products, using the new domains as at least some of the additional URIs.

7. The method of claim 1, wherein the brand asset terms include a product name, a brand name, and a domain name associated with the enterprise.

8. The method of claim 1, further comprising collecting the brand asset terms from predetermined spam email lists and phishing website lists accessible in a database, and from social media sites.

9. The method of claim 1, wherein the focused search includes searching of search engine results generated using Black hat search engine optimization techniques, targeted social media posts, marketplace search application programming interfaces, spam email lists, and phishing website lists.

10. The method of claim 1, wherein the removing includes intervening against the blacklist URIs to remove access to the blacklist URIs.

11. An apparatus comprising:
a network interface unit to communicate with a network; and
a processor coupled to the network interface unit and configured to perform:
performing a focused search to find uniform resource identifiers (URIs) of potentially counterfeit products and/or fake assets online based on brand assets terms associated with an enterprise;
performing a search for adjacencies of blacklist URIs of counterfeit products and/or fake assets online to find additional URIs of potentially counterfeit products and/or fake assets online that are related to the blacklist URIs;
adding the URIs and the additional URIs to a URI list;
classifying, by a machine learning classifier, each URI on the URI list as one of a blacklist URI of counterfeit products and/or fake assets online, and a whitelist URI of authentic products and/or assets online that are not counterfeit or fake;
repeating (i) the performing the search for adjacencies using blacklist URIs resulting from the classifying, (ii) the adding, and (iii) the classifying, to cause the URI list, a number of blacklist URIs, and a number of whitelist URIs to expand from the repeating; and
removing access to counterfeit and/or fake assets online revealed by the focused search, the search for adjacencies, or the classifying.

12. The apparatus of claim 11, wherein:
the processor is configured to perform the classifying by classifying each URI on the URI list as an undetermined URI of products and/or assets online when the classifying is unable to classify the URI as either a blacklist URI or a whitelist URI; and
the processor is configured to the performing the search for adjacencies by performing the search for adjacencies of undetermined URIs resulting from the classifying to identify additional URIs of potentially counterfeit products and/or fake assets online to be added to the URI list for the classifying.

13. The apparatus of claim 11, wherein the processor is further configured to perform:
performing web crawling of each URI found by the focused search and the search for adjacencies; and
adding the URIs resulting from the web crawling to the URI list, such that the classifying includes classifying each URI resulting from the focused search, the search for adjacencies, and the web crawling.

14. The apparatus of claim 11, wherein the processor is further configured to perform:
providing whitelist URIs resulting from the classifying to a supervised learning input of the machine learning classifier to train the machine learning classifier.

15. The apparatus of claim 11, wherein the processor is configured to perform the performing the search for adjacencies by:
discovering backlinks associated with each blacklist URI, and using the backlinks as at least some of the additional URIs.

16. The apparatus of claim 11, wherein the brand asset terms include a product name, a brand name, and a domain name associated with the enterprise.

17. A non-transitory computer readable medium encoded with instructions that, when executed by a processor, are operable to perform:
performing a focused search to find uniform resource identifiers (URIs) of potentially counterfeit products and/or fake assets online based on brand assets terms associated with an enterprise;
performing a search for adjacencies of blacklist URIs of counterfeit products and/or fake assets online to find additional URIs of potentially counterfeit products and/or fake assets online that are related to the blacklist URIs;
adding the URIs and the additional URIs to a URI list;
classifying, by a machine learning classifier, each URI on the URI list as one of a blacklist URI of counterfeit products and/or fake assets online, and a whitelist URI of authentic products and/or assets online that are not counterfeit or fake;
repeating (i) the performing the search for adjacencies using blacklist URIs resulting from the classifying, (ii) the adding, and (iii) the classifying, to cause the URI list, a number of blacklist URIs, and a number of whitelist URIs to expand from the repeating; and
removing access to counterfeit and/or fake assets online revealed by the focused search, the search for adjacencies, or the classifying.

18. The non-transitory computer readable medium of claim 17, wherein:
the instructions operable to perform the classifying include instructions operable to perform classifying each URI on the URI list as an undetermined URI of products and/or assets online when the classifying is unable to classify the URI as either a blacklist URI or a whitelist URI; and
the instructions operable to perform the performing the search for adjacencies include instructions operable to perform performing the search for adjacencies of undetermined URIs resulting from the classifying to identify additional URIs of potentially counterfeit products and/or fake assets online to be added to the URI list for the classifying.

19. The non-transitory computer readable medium of claim 17, further comprising instructions operable to perform:
performing web crawling of each URI found by the focused search and the search for adjacencies; and
adding the URIs resulting from the web crawling to the URI list, such that the classifying includes classifying each URI resulting from the focused search, the search for adjacencies, and the web crawling.

20. The non-transitory computer readable medium of claim 17, wherein the brand asset terms include a product name, a brand name, and a domain name associated with the enterprise.
